(19) United States
(12) Patent Application Publication
(10) Pub. No.: US 2012/0274646 A1
(43) Pub. Date: Nov. 1, 2012

(54) LASER PARTICLE PROJECTION SYSTEM

(76) Inventor: Randy Johnson, Escondido, CA (US)

(21) Appl. No.: 13/409,069

(22) Filed: Feb. 29, 2012

Related U.S. Application Data
(60) Provisional application No. 61/480,502, filed on Apr. 29, 2011.

(51) Int. Cl. G06T 1/00

(52) U.S. Cl. 345/501

(57) ABSTRACT

A projection system and a method for generating special laser particle effects are provided. The projection system may comprise a computer processor and an arrangement. The computer processor may be configured to generate a laser particle effect. The arrangement may be configured to display the laser particle effect on a surface by using a coherent light source.

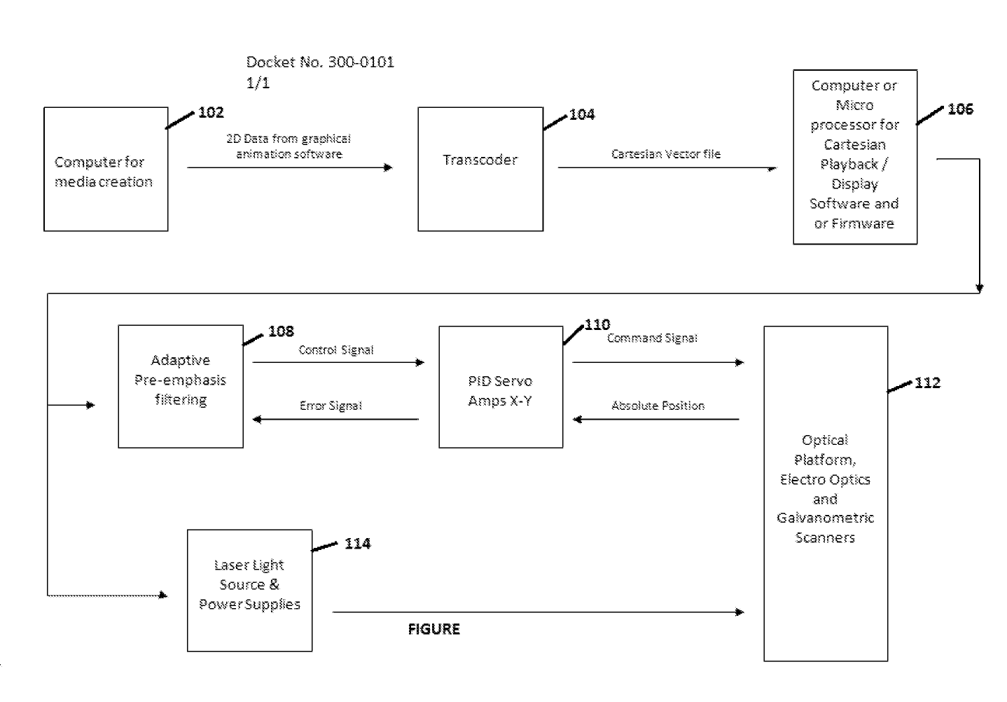

### RELATED APPLICATIONS

The present application claims benefit of U.S. Provisional Application No. 61/480502 filed on Apr. 29, 2011, the entirety of which is incorporated herein by reference.

### BACKGROUND OF THE INVENTION

The present invention relates generally to a method and system for producing lighting effect and, more specifically, to a system and method for producing laser particle projection.

There are many settings where it is desirable to provide unique lighting and visual effects. For example, concerts may include special lighting to show more visual excitement for participants. Additionally, moving light streams may be used to surprise people or draw their attention to a particular location.

Entertainment and event lighting has been provided through the use of lasers. A laser may be provided in a projector along with optical elements to create a constant or a randomly changing or random display of thousands of pin points of light by having the optical elements stationary or moving within the projector. However, current particle special effect lighting systems typically use video or film projection which incorporates a standard light source, such as a filament bulb or gas discharge lamp. The drawback with these technologies is a reduced contrast ratio, brightness, limited field of focus and color saturation.

Therefore, it can be seen that there is a need for a method and system to improve contrast ratio, brightness, limited field of focus and color saturation when presenting particle special effect lighting.

### SUMMARY OF INVENTIONS

In one aspect, a projection system for generating special particle effects comprises a computer processor configured to generate a laser particle effect; and an arrangement configured to display the laser particle effect on a surface by using a coherent light source.

In another aspect, a method of producing particle lighting special effects may comprise creating a file having laser particle effects; and displaying laser particle effects by a laser projector.

In yet another aspect, a computer readable medium may have computer usable program code embodied therewith. The computer program code may comprise computer program code configured to create a file having laser particle effects; and computer program code configured to convert the file into a file format compatible with a laser projector and its support component.

These and other features, aspects and advantages of the present invention will become better understood with reference to the following drawings, description and claims.

### BRIEF DESCRIPTION OF THE DRAWINGS

The FIGURE is a detailed flow chart of a laser projection system according to an exemplary embodiment of the present invention.

### DETAILED DESCRIPTION OF EMBODIMENTS

The following detailed description is of the best currently contemplated modes of carrying out exemplary embodiments. The description is not to be taken in a limiting sense, but is made merely for the purpose of illustrating the general principles, since the scope of the embodiments is best defined by the appended claims.

Various inventive features are described below that can each be used independently of one another or in combination with other features.

Broadly, exemplary embodiments comprise a system for projecting light upon surfaces. More specifically, exemplary embodiments of the present invention provide a system and method for projecting special laser particle effects onto a display surface.

Exemplary embodiments may take the form of an entire hardware embodiment, an entire software embodiment (including firmware, resident software, micro-code, etc.) or an embodiment combining software and hardware aspects that may all generally be referred to herein as a “circuit,” “module” or “system.” Furthermore, exemplary embodiments may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction performance system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireless, wire line, optical fiber cable, RF, etc.

Computer program code for carrying out operations of exemplary embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Exemplary embodiments are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Referring to FIGURE, a projection image may be made on a computer with a graphic production program in a step 102. The projection image, such as particle special effects, for example, may be created in a host computer. Alternatively, the particle special effects may be created on another computer and may be transferred over to the host computer. The graphic production program may include 3D graphics, modeling, animation, rendering application, e.g., 3D studio max, Cinema 4D®, Maya, Adobe® after Effects®, or other 3D graphic production programs which embody particle emitters. The graphic production program may be used to create the projection which may consist of color, size, trajectory, and other attribute, for example.

A main platform to create laser particle effects may comprise the following elements: particle emitters, P-clouds, P-cloud arrays, drag forces including gravity, drag, momentum, mass, inertia, collision, and any physical constants that may be applied to the physical behavior of the particle lighting elements.

The particle emitter may have function of applying forces or physical constants to particles and particle effects. In another exemplary embodiment, the particle emitter function may allow users to bind particles and particle effects to trajectories or animate particles. Users may choose a graphic animation rendering program where they may control the lighting appearance of the particles and create frames of animation.

The projection image may consist of color, size, trajectory and other attributes. The computer may create 2D data that are used to represent the numerical and graphical information that represents a desired object.

In a step 104, the information may be sent to a transcoder. The transcoder may be a software plugin or a standalone software application, for example, installed into the graphical production software. The transcoder may be used to interpret and create X-Y coordinates, color and other data from the 2D data. The transcoder may turn the 2D data created in the production software into a Cartesian vector file which may be compatible with a laser projector and all of its support components. The support components may comprise a Cartesian based galvanometric scanning system, a digital micro-mirror device, a liquid crystal on silicon, lasers, laser electro-optics, and necessary electronic systems and subsystems.

In a step 106, the Cartesian vector data may be viewable in display software, which may allow the transcoded data to be manipulated. Through the display software, users may change chromaticity, hue, brightness, saturation, geometric attributes, time line events, audio synchronization, and final appearance of the particles. If manipulation is not needed, the data may be sent through a microprocessor that finalizes the data for galvanometric scanners or other components.

In a step 108, the data may be sent through an adaptive pre-emphasis filter. By using the pre-emphasis filter prior to a proportional integral derivative (PID) servo amplifiers, the data may be tested and modified before reaching the PID servo amplifiers. The system may optimize the data insuring that the best possible projection may be made. As in electronic audio signals, the data used in the projection system may be distorted or altered. Sending the data through the pre-emphasis filter may optimize the data and ultimately the projection.

Once the data is optimized and filtered, part of it may be sent to the PID servo amplifiers in a step 110. The data may contain analog command or control signals about the X-Y coordinates. The servo amplifiers may alter the data so it may be used by the galvanometric scanners. The galvanometric scanners may be mirrors mounted on an end of a shaft. The galvanometric scanners may be moved to reflect the lasers and create the projection.

An error signal derived from the PID servo amplifiers may be configured by the adaptive pre-emphasis filter to modify the control signal. The control signal may be provided to the PID servo amplifiers to improve response and to settle time of the galvanometric scanners, or to improve a signal to noise ratio whereas the signal is optimized and the unused harmonics produced in a resonant system may be reduced or eliminated.

If users send a different type of data through the amplifiers while they are tuned for something else, users may end up with a distorted or altered projection. However, if users use a real time PID to analyze and monitor the data going through the servo amplifiers, the real time PID may make changes to the servo amplifier settings optimizing the projection in real time. The PID servo amplifiers and galvanometric scanners may be monitored by the real time PID, which ensures that the data being sent through is optimized. The command signal may be sent to the galvanometric scanner as the galvanometric scanner sends back the absolute position to the PID in a step 112. Thus, the real time PID may make changes to ensure that the projections accrue in the proper location.

In a step 114, the other part of analog signal data may be sent to the laser light sources and power supplies in the form of changing voltage or a change in current, for example. The changing voltages may supply the power source that the data needs to turn the lasers on and off at the right time to get the right color. The PID of the laser electro-optical hardware may monitor the laser light sources, their output, quality of projection, performance over their lifetime, for example, which may help to maintain safety and make sure that the projection stays in preset parameters.

Since some laser light sources change over time, the PID may modify and analyze them resulting in possible changes to other parts of the projector. The PID may also monitor to make sure the projection is made to certain specifications or done within certain parameters. The system may also include a learning PID which may help the system correct itself. The learning PID may give the projector self-awareness and may make change in real time to accommodate for wear and tear.

The system may further include thermal duration of the electrodynamics optical system. By using thermally duration of the electrodynamics optical system, users may allow the system to accommodate a larger thermal load and increase the amount of volumetric data users put through.

The PID servo amplifier and laser light source and power supplies may meet at the optical platform and electro optics that create the laser projections.

It should be understood, of course, that the foregoing relate to exemplary embodiments of the invention and that modifications may be made without departing from the spirit and scope of the invention as set forth in the following claims.

We claim:

1. A projection system for generating special particle effects, comprising:
a computer processor configured to generate a laser particle effect; and
an arrangement configured to display the laser particle effect on a surface by using a coherent light source.

2. The projection system of claim 1, wherein the coherent light source is a laser.

3. The projection system of claim 1, further comprising a proportional integral derivative controller.

4. The projection system of claim 1, further comprising a galvanometric scanner to reflect coherent light.

5. The projection system of claim 4 further comprising a shaft whereby the galvanometric scanner is mounted on the shaft.

6. The projection system of claim 1 further comprising a servo amplifier configured to alter data.

7. The projection system of claim 6 further comprising a pre-emphasis filter configured to test and modify data before sending to the servo amplifier.

8. The projection system of claim 1, wherein the arrangement is a laser projector.

9. The projection system of claim 3, wherein the proportional integral derivative controller is a real time proportional integral derivative controller.

10. The projection system of claim 3, wherein proportional integral derivative controller is a learning proportional integral derivative controller.

11. A method of producing particle lighting special effects, comprising:
creating a file having laser particle effects; and
displaying laser particle effects by a laser projector.

12. The method of claim 11, further comprising converting the file having laser particle effects into a file format compatible with a laser projector and its support component.

13. The method of claim 11, further comprising sending the file having laser particle effects to a transcoder.

14. The method of claim 11, further comprising manipulating the file having laser particle effects.

15. The method of claim 11, further comprising converting the file having laser particle effects into a Cartesian vector file.

16. A computer readable medium having computer usable program code embodied therewith, the computer program code comprising:
computer program code configured to create a file having laser particle effects; and
computer program code configured to convert the file into a file format compatible with a laser projector and its support component.

17. The computer readable medium of claim 16, further comprising computer program code configured to send the file having laser particle effects to a transcoder.

18. The computer readable medium of claim 16, further comprising computer program code configured to manipulate the file having laser particle effects.

19. The computer readable medium of claim 16, further comprising computer program code configured to save the file having laser particle effects.

20. The computer readable medium of claim 16, further comprising computer program code configured to display the file having laser particle effects.
